(19) United States
(12) Patent Application Publication
(10) Pub. No.: US 2003/0167948 A1
(43) Pub. Date: Sep. 11, 2003

(54) Method and apparatus for steam cleaning anilox inking rollers

(76) Inventor: Martin J. Weitz, Formington Hills, MI (US)

Correspondence Address: Martin Weitz, MJW Investments Inc., 800 Denison Ct., Bloomfield Hills, MI, 48302, US

(21) Appl. No.: 10/090,123

(22) Filed: Mar. 5, 2002

(51) Int. Cl. B41F 35/04

(52) U.S. Cl. 101/425

(57) ABSTRACT

A method and apparatuses to safely and easily remove dried ink and foreign other materials from the surface of anilox rollers using one or more jets of high pressure steam.

### FIELD OF THE INVENTION

The instant invention relates to cleaning of anilox rollers used in flexographic printing processes. More specifically the instant invention relates to a method and apparatuses to safely and easily remove dried ink and foreign other materials from the surface of anilox rollers using one or more jets of high pressure steam.

### BACKGROUND OF THE INVENTION

The flexographic printing process or flexography is a process of direct rotary printing of images onto an elongated web of moving substrate material. The process is typically utilized for product packaging and containers in many different industries.

Anilox rollers utilized in the flexographic printing process have evolved considerably over the years. Anilox rollers typically come in three types of constructions. The first is a ceramic coating disposed over a knurled surface on a metal cylinder, the second is a chrome-plated surface over a knurled surface of a cylinder, and the third is a laser engraved ceramic surface on a cylinder. In each construction, a plurality of small or microscopic pockets or cells are formed in the coating material of the cylinder in order to carry ink, adhesive or other coating material from a reservoir to a printing plate cylinder and then from the printing plate to the substrate web. The size of the cells in the surface of the anilox roller determines how much ink or other material each cell will carry. The anilox roller rotates and contacts the printing plate cylinder, thereby transferring the material in the cells to the plates. The engraving process for the cells can create different diameters, depths, shapes and placement angles of cells in order to meet the needs of a particular printing or other process.

Chrome and ceramic coated engraved knurled anilox rollers typically can only have about 500 cells per inch because of the limitations of the technology for forming such a roller. Most printing requirements for today's industries require very precise image and fluid transfer for which the coated knurled engravings are not well suited. Therefore, the laser engraved ceramic rollers offer many advantages over the other two types of anilox rollers. The cells of a laser engraved anilox roller can be formed having a density upwards of 1200 cells per inch with highly precise control of the shape, depth, size and steepness of the cell walls. This precision is not available in other types of anilox roller construction. The depth and therefore volume of each laser engraved cell can be significant, although the actual diameter or size of the cells can remain very small.

The laser engraved anilox rollers also offer much better durability than these other types of anilox rollers. However, the cost of such rollers is significantly greater because of the high precision manufacturing process necessary to produce the ceramic coated anilox roller. Another significant problem with anilox rollers is the difficulty in cleaning dried ink or other dried or hardened substance residue from the surface and cells of the roller. This difficulty is caused by the very small microscopic size of the cells and the greater depth to which they are formed into the ceramic surface of the roller. Dried ink or other substances plugs the cells and is very difficult to remove from the anilox roller. The ink or material film flow quality is significantly decreased if an anilox roller is dirty and has clogged or plugged cells because the precision and volume of ink or other material transferred from the reservoir to the plate cylinder is reduced or altered. The metering function of the roller is thus inhibited. Dried ink can occur in all of the cells of the roller or only a portion of the cells depending upon the particular printing process being run. However, any dried ink or other substance occurring in any part of the roller surface causes reduced print quality and ink delivery.

There are a number of known methods and apparatuses used for cleaning anilox rollers. Some of these methods are quite effective while some methods are not. However, the effective methods as well as most of the ineffective methods are very costly, time consuming, require machine downtime and can cause damage to the anilox rollers.

For example, there are ultrasonic cleaners available whereby one or more anilox rollers are partially or completely submerged in a tank containing a highly caustic cleaning fluid. High frequency sound waves are generated in the caustic liquid medium to create microscopic air bubbles that implode on impact with the cells and the cell walls. The implosions force the caustic fluid into the cells to remove dried ink and other substance residue. This type of cleaning system is extremely expensive and is very time consuming. The ultrasonic cleaning equipment also requires its own maintenance, storage and upkeep. The caustic cleaning fluid requires special handling and storage and also requires time consuming and expensive precautionary safety measures be taken during the cleaning process. The use of the equipment requires that the anilox rollers be removed from the flexographic printing machine in order to be cleaned thus creating down time for the machine.

High pressure cleaning systems are another type of system used wherein an anilox roller is placed in a stream of a media ejected from a device at high pressure. The media can be a particle media such as small microscopic plastic particles or a sodium bicarbonate or baking soda specially designed to clean anilox rollers. The media can also be a cleaning liquid or fluid wherein jets or nozzles create an overlapping spray pattern impacting the anilox roller surface. Sometimes the cleaning liquid or fluid is heated to further facilitate cleaning. In some media blast systems, the roller is entirely submerged in the fluid media. Alternatively, some pressure wash systems rotate the roller in an ambient environment whereby a cleaning solution is ejected from nozzles toward the surface of the roller. In this type of system the rollers are not submerged in the cleaning media. Fluid pressure wash systems are less expensive in comparison to other hard media blast systems and when compared to ultrasonic systems. However, the media blast systems and the pressure wash systems are still relatively expensive and require maintenance, storage and upkeep of the equipment as well. Significant downtime of the flexographic printing machine also is necessary since the roller must typically be removed from the machine to be cleaned. There are a few media blast machines available that can attach directly to the flexographic press in order to clean the anilox roller on press. However, this type of machine must be attached and removed for each cleaning and is very cumbersome and expensive to operate and maintain. These machines also incorporate a large, high power vacuum or suction system to collect all of the media. The suction system is also very cumbersome and expensive.

Some cleaning systems utilize a pressurized vapor injection cleaning system wherein the rollers are placed in a stream of a vapor chemical composition. This type of system can be utilized directly on the flexographic machine because very little if any liquid is involved in the cleaning process. This system is fairly inexpensive and portable although again it requires maintenance and storage of the cleaning equipment and requires purchase and storage of the chemical vapor product as well. This type of system is not effective for all types of inks and coating materials and typically has not proven effective for heavy industrial printing processes where heavy and continuous cleaning is required for the anilox rollers.

Another type of system for cleaning anilox rollers involves utilizing the ink reservoir of the flexographic press for cleaning the cells of the anilox roller. This type of system is utilized where the ink is flushed out of the system and then a cleaning solution is replaced in the reservoir and utilized to clean out the cells. This type of system is relatively recent, expensive, and fairly ineffective at removing deeply embedded materials within the cells. A risk exists of not flushing out all of the cleaning solution from the system and then contaminating the subsequently run printing process. This type of self-contained system also requires significant machine downtime.

Manual cleaning is often utilized and even recommended for quick cleaning of anilox rollers. The manual cleaning process involves utilizing a wire brush for agitating ink on the surface and within the cells of the anilox roller. The brush is utilized along with a water based detergent or solvent based cleaner. The types of brushes typically utilized are brass or stainless steel bristle brushes wherein the stainless brushes are always utilized for ceramic rollers. This type of cleaning process is very messy, is very time consuming, can damage the ceramic coating if the wrong brush is used, and is limited in its effectiveness for the laser formed ceramic cells of modern anilox rollers. Most times the diameter of the brush bristles is much larger than the diameter of the cells and therefore the material deep within the cells cannot be readily dislodged.

All of these methods usually require removal of the anilox roller from the press prior to cleaning. Some rollers are on the order of sixty inches long or longer and can weigh upwards of a half a ton. A crane or hoist is often used to remove the larger rollers from the press and transport them to the cleaning apparatus or station. The removal is time consuming and requires significant downtime of the press. Manufacturers often recommend keeping a second replacement roller around for this very reason. However, some of the larger rollers can cost tens of thousands of dollars each. The ceramic surface of an anilox roller is very wear resistant and durable. However, the ceramic is also brittle and can be easily damaged upon impact with an object. Each removal of a roller for cleaning therefore also raises a risk of permanently damaging the roller surface.

Another commonly utilized method for cleaning anilox rollers is chemical cleaning whereby relatively harsh chemicals are utilized such as solvents, acids and common strong household cleaners which dissolve or re-wet the ink or other substances lodged within the cells. Chemical cleaning, as with virtually all cleaning methods first requires rinsing off or initially wiping the anilox roller to remove most of the wet ink or other substance from the last press run. Then the solution is applied and the anilox roller is wiped to completely cover the surface of the roller. The chemical compositions also require a dwell time so that the composition sits for a period of time on the rollers to react with the deeply embedded and dried substance plugging the cells. The anilox roller is then wiped down with the composition in order to clean the surface. A rinsing process must then be undertaken to remove all of the caustic chemical materials from the surface of the anilox roller as well as from the cells in order to prevent any unwanted residue from fouling up a subsequent print process. A drawback with this type of method is that the rolls must again be removed from the flexographic printing machine so that the chemicals do not contaminate any other portion of the processed components. A further drawback is that this method requires time consuming steps including removing the roller from the press, quick cleaning most of the wet ink from the last print job, applying the chemical composition, letting it sit for a period of time, wiping the roller to clean it, cleaning the chemical from the roller, rinsing the roller with water, and replacing the roller on the press. Another drawback is that this type of cleaning has been found to be ineffective for deeply embedded and dried ink from within the cells of the roller. The advent of the much more expensive and time consuming cleaning methods discussed above are a result of the ineffectiveness of these chemical solution cleaning methods. It should also be noted that many of the prior art methods are costly, somewhat destructive to the anilox roller and some of the methods are not environmentally friendly. Thus, there is a need in the art for a method and associated apparatuses for cleaning anilox rollers that is simple, inexpensive, non-destructive to the anilox roller and environmentally friendly.

### SUMMARY OF THE INVENTION

The instant invention comprises a method of cleaning surfaces of an anilox roller comprising the steps of: providing an anilox roller having surfaces to be cleaned of dried ink and other material residue; providing a source of pressurized steam; and directing a jet of said pressurized steam from said source thereof onto said surfaces of said anilox roller, thereby removing said dried ink and other material residue from said surfaces of said anilox roller.

The instant invention further comprises apparatuses for performing the method of the instant invention. In its simplest form the apparatus includes a source of pressurized steam; means for holding and rotating said anilox roller; and means for directing at least one jet of pressurized steam onto the surfaces of said anilox roller to remove said dried ink and other material residue.

### BRIEF DESCRIPTION OF THE DRAWINGS

FIG. 1 illustrates a schematic of the flexographic printing process;

FIG. 2 illustrates a perspective view of a conventional anilox roller used in flexographic printing;

FIG. 3 illustrates an enlarged view of a portion of the laser engraved ceramic coating on the surface of a conventional anilox roller;

FIG. 4A illustrates a cross-section through one of the cells of the laser engraved ceramic coating which is clean and free of dried ink and other material residue;

FIG. 4B illustrates a cross-section through one of the cells of the laser engraved ceramic coating which is plugged with dried ink and other material residue;

FIG. 5 is a schematic illustration of a first basic apparatus for use with the method of the instant invention;

FIG. 6 is a schematic illustration of a second apparatus for use with the method of the instant invention, specifically shown is an automatic cleaning apparatus with a raster scanning cleaning head;

FIG. 7 is a schematic illustration of a third apparatus for use with the method of the instant invention, specifically shown is an automatic cleaning apparatus with a full roll-length cleaning head;

FIG. 8A is a schematic illustration of a fourth apparatus for use with the method of the instant invention, specifically shown is an automatic cleaning apparatus with a cleaning head which is mounted on a pivot;

FIG. 8B is a schematic illustration of the fourth apparatus where the cleaning head is pivoted away from the anilox roller and shut off.

### DETAILED DESCRIPTION OF THE INVENTION

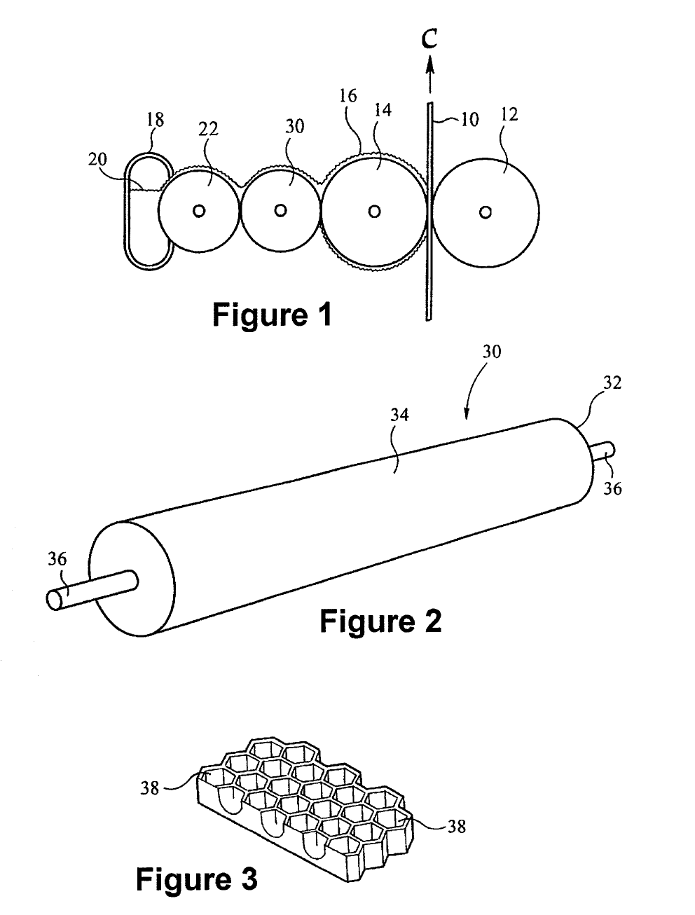

FIG. 1 illustrates a schematic of the flexographic printing process wherein a web 10 of material is moved by a flexographic printing machine (not shown) in a direction “C” and rests on one side against an impression cylinder 12 which supports the web. A plate cylinder 14 is disposed on the opposite side of the web 10 and carries on its external surface a plurality of relief image plates 16. The image plates provide the printed images to be transferred onto the web from the plate cylinder 14. A fluid supply reservoir 18 carries a supply of fluid 20, typically of the solvent or water based fast drying fluid ink variety. The fluid 20 is transferred from the reservoir 18 to the plate cylinder 14 by a metering roller 22 and an anilox roll or roller 30. The size and construction of the anilox roller 30 can vary greatly but must provide a highly precise volume of fluid such as ink delivered to the plate cylinder 14 in order to produce high definition, resolution and quality images on the web 10.

FIG. 2 illustrates a perspective view of a conventional anilox roller construction. An anilox roller 30 includes an elongate metal circular cylinder 32 typically machined from a solid bar of steel or other metal. The cylinder 32 has an outer surface that carries thereon a laser engraved ceramic coating 34. A shaft extension 36 extends from each end of the cylinder 32 for connection to appropriate associated components of a flexographic printing machine or the like. The shafts 36 are typically carried by journal bearings such that the roller 30 rotates about the shafts 36 in the machine.

FIG. 3 illustrates an enlarged view of a portion of the ceramic coating 34 carried on the cylinder 32. A plurality of cells 38 are laser engraved in the surface of the ceramic coating 34 of the cylinder 32. The laser engraved anilox roller typically consists of a plasma-sprayed ceramic coating which is typically a chromium oxide, that is ground and honed to an extremely smooth finish. The ceramic coating is extremely hard, having a micro-hardness on the order of 1100-1300 Vickers. In comparison, the hardness of the less attractive chrome plating anilox rollers is around 850-950 Vickers. Other types of anilox rollers are steal rollers having a knurled surface to form the cells. Alternatively, a knurled surface has a ceramic coating or a chrome plated ceramic surface defining the cells. The present invention is not to be limited to the particular construction of an anilox roller described. However, the invention is particularly useful for the laser engraved anilox roller because of the very fine definition and high density of cells.

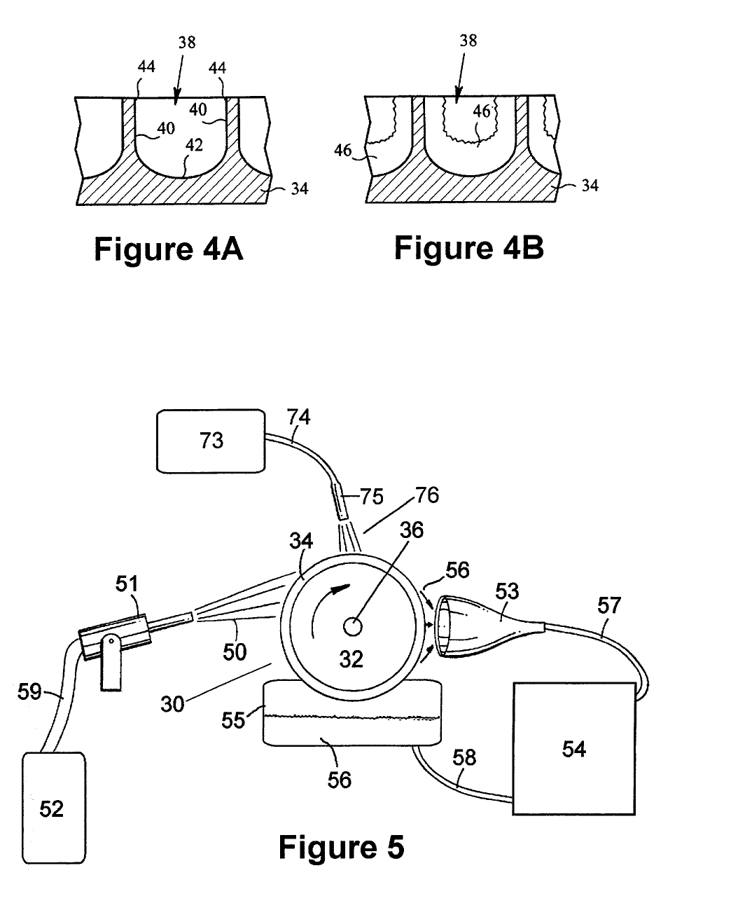

The shape, depth, diameter and particular wall thickness of the cell construction for an anilox roller can vary considerably depending upon the particular printing requirements of the flexographic printing process and upon the type of ink and amount of ink utilized for a particular process. The embodiment illustrated in FIG. 3 shows a typical honeycomb construction for the cells. FIG. 4A illustrates a cross-section through one of the cells wherein the cell is clean and free of dried ink and other material residue. The cell 38 includes a cell wall 40, a cell bottom and an upper cell opening 44. FIG. 4B illustrates the cell 38 in a plugged condition wherein ink residue 46 is disposed in the bottom 42 of the cell as well as along a portion of the walls 40 of the cell. The amount of residue 46 determines the actual volume size of the particular cell 38 wherein the more residue disposed within the cell the less the ink volume of the cell. Thus, the residue 46 reduces the volume of the cell, which in turn alters the ink carrying capabilities of the roller. A particular cell volume of the clean cell 38 is specifically designed to achieve a particular print characteristic and therefore must be kept clean in order to maintain the precise print qualities. For purposes of this disclosure, the term “surfaces” will be used to indicate all of the surfaces interiorly situated withing the cells 38 and any surfaces exteriorly situated from the cells.

The instant inventors have found that a jet of pressurized steam is a useful and practical cleaning material for the cells 38 of anilox rollers. The pressurized steam has a pressure of up to about 1600 psi, and is preferably between 50 and 600 psi and more preferably between 50 and 250 psi. The pressurized steam has a temperature of up to 350° F., more preferably between 220 and 300° F., and most preferably between 220 and 260° F. The jet of steam, because it is formed of vaporized water at high temperature and flows at a high velocity, is a very versatile cleaning material. First, the high temperature steam is a very good solvent for water based inks and other water based materials, because, of course, steam is composed of vaporized water (in some instances the steam will contain up to 10% liquid water, which aids in rinsing the anilox roller). Thus the steam quickly wets the dried ink, more readily than even liquid water would if used in a water/air aerosol jet. The high temperature steam may also melt and or soften other non-water-soluble residue materials embedded within the cells 38 of the anilox roller 30 making them easier to remove. Finally the high pressure of the steam creates a jet of steam which has a high velocity. This high velocity jet blasts steam into the cells 38 which, in turn, causes the re-wetted ink and other residue materials to be ejected out of the cells. Once the re-wetted ink and other residue materials are forced out of the cells 38 of the anilox roller 30, the ink and debris need to be removed from the roller and collected for disposal.

The method of the present invention involves the steps of: 1) providing an anilox roller having surfaces to be cleaned; 2) providing a source of pressurized steam; and 3) directing a jet of the pressurized steam onto the surface of the anilox roller, thereby removing dried ink and other material residue from the surfaces of the anilox roller. The method can further include the step of collecting the removed ink and other material residue from the roller via gravity-fed liquid collection, vacuum collection, or both. The method can additionally include the step of transporting the collected ink and other material residue to a disposal system. The method may also include the further step of disposing of the collected ink and other material residue.

While this method is very useful for cleaning the surfaces of anilox rollers which have become clogged by dried water-based inks and other solid residue. The inventor has found that it may also be useful to provide a small spray of liquid water to the anilox roller after the jet of pressurized steam to help rinse the ink and residue from the roller before the ink and residue material has an opportunity to dry. Therefore the method may optionally include the step of spraying liquid water onto the surfaces of the anilox roller after the step of steam jet cleaning.

The high pressure steam is also quite effective at removing dried non-water-based inks as well. The inks soften and flow under temperature and pressure of the steam jet and can thus be removed from the roller. However the inventor contemplates that it may be useful to provide the surfaces of the anilox roller with a surfactant or degreasing compound to make the non-water-based materials more readily soluble in the jet of steam. The surfactant or degreasing compound would preferably be provided on the surface of the roller before the jet of steam and may be manually deposited onto the roller or may be automatically sprayed onto the surface of the roller. Thus the method may also optionally include the step of providing a surfactant or degreasing compound on the surfaces of the anilox roller before the step of steam jet cleaning. It should be noted that both the liquid water and surfactant or degreasing compound may be used in combination.

FIG. 5 is a schematic illustration of a first basic apparatus for use with the method of the instant invention. The apparatus includes a steam jet nozzle 51 which directs a jet of pressurized steam 50 onto the surfaces 34 of the anilox roller 30 which may be rotating on it's shaft 36. The steam jet nozzle 51 is supplied with steam through steam supply line 59 from a source of pressurized steam 52. As the steam cleans the surfaces of the anilox roller, the waste ink and residue 56 is collected from the roller and transported for disposal. The collection can be achieved with either a vacuum collection system including a vacuum port 53 or a gravity-fed liquid collection system including a liquid drip pan 55, or both in combination. Finally, once the waste ink and residue 56 is collected from the roller 30, it travels via waste disposal lines 57 (vacuum waste disposal line) and 58 (liquid waste drain line) to a residue disposal means 54. The apparatus may further, optionally, include an additional spray nozzle 75 which would spray a small stream of liquid water, a surfactant or a degreasing compound 76 onto the surfaces 34 of the anilox roller 30. The liquid water, surfactant or degreasing compound is supplied to the spray nozzle 75 via supply line 74 from a source thereof 73. Such a basic design as this may be used as a portable hand held cleaning unit.

It should be noted that throughout the descriptions of the embodiments of apparatuses useful for practicing the instant method, there is always a means for mounting and rotating the anilox roller to allow the entire surface of the anilox roller to be cleaned. The means for mounting and rotating the anilox roller may be the mounting and rotating devices of the flexographic printer if the anilox roller is cleaned without being removed therefrom.

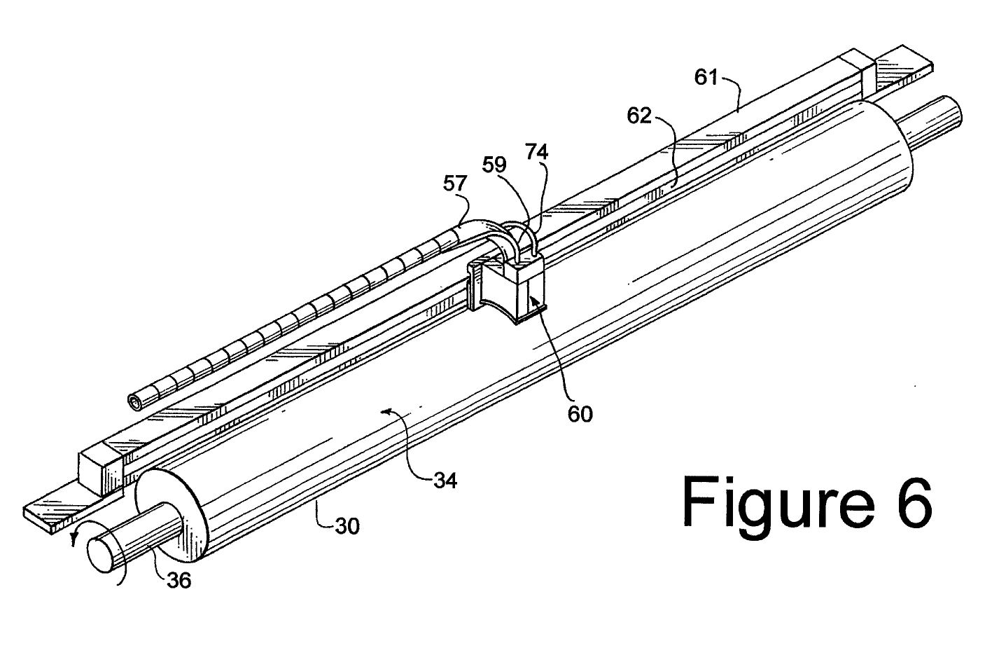

FIG. 6 is a schematic illustration of a second embodiment of an apparatus for use with the method of the instant invention. In this embodiment, one or more steam nozzles, vacuum ports, and liquid water, surfactant or degreasing compound spray nozzles (none shown) are combined into a single cleaning head 60. The cleaning head 60 directs at least one pressurized jet of steam onto the surfaces 34 of the anilox roller 30 which may be rotating on shaft 36. Steam is supplied to the cleaning head 60 via a steam supply line 59, and the liquid water, surfactant or degreasing compound is supplied to the cleaning head 60 via supply line 74. As with the basic design, the waste ink and residue is collected from the roller by vacuum collection and travels via waste disposal line 57 to a waste disposal means. During cleaning of the anilox roller 30, the cleaning head 60 is raster scanned back and forth along the length of the roller, thus exposing the entire length of the roller to the cleaning head 60. The cleaning head 60 is raster scanned across the length of anilox roller 30 within track 62 of traction unit 61. It should be noted that the speed of the scanning of the cleaning head 60 and the rotation of the anilox roller 30 are coordinated to ensure that the entire roller is cleaned. The apparatus of this embodiment may be used either in a stand alone configuration where the anilox roller is removed from the flexographic printer and cleaned in the cleaning unit or the apparatus may be temporarily or permanently attached to the flexographic printing machine to clean the anilox roller.

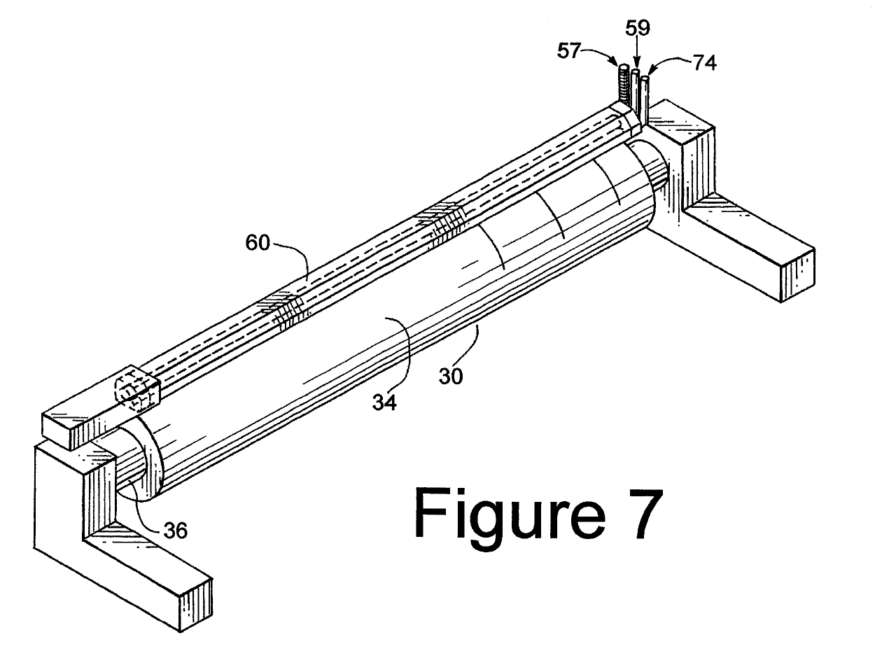

FIG. 7 is a schematic illustration of a third embodiment of an apparatus for use with the method of the instant invention. In this embodiment, one or more steam nozzles, vacuum ports, and liquid water, surfactant or degreasing compound spray nozzles (none shown) are combined into a single cleaning head 60 which extends the entire length of the anilox roller 30. Thus the entire length of the surfaces 34 of the anilox roller 30 is cleaned at once while the roller 30 rotates on shaft 36. Once again, steam is supplied to the cleaning head 60 via steam supply line 59, the liquid water, surfactant or degreasing compound is supplied to the cleaning head 60 via supply line 74, and the waste ink and residue are collected from the roller by vacuum suction and travel via one or more waste disposal lines 57 to a disposal means. As with the previous embodiment, the apparatus of this embodiment may be used either in a stand alone configuration where the anilox roller is removed from the flexographic printer and cleaned in the cleaning unit or the apparatus may be temporarily or permanently attached to the flexographic printing machine to clean the anilox roller.

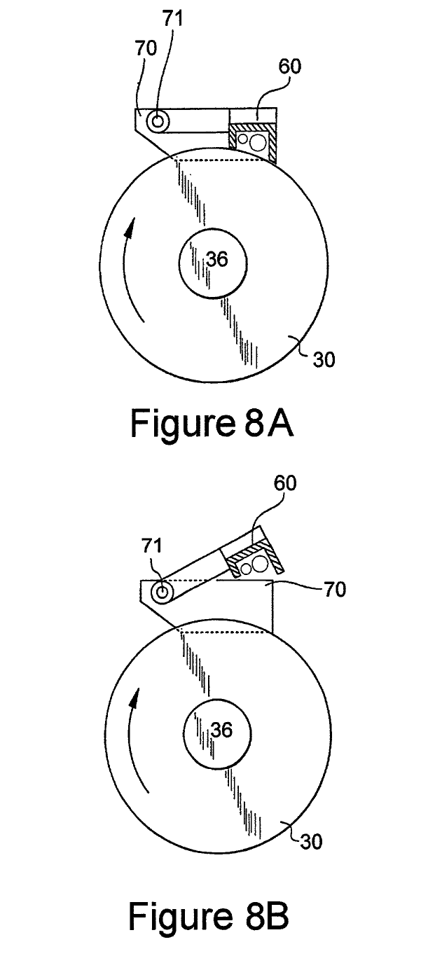

In a fourth embodiment, depicted in FIGS. 8A and 8B, an apparatus as in the second or third embodiments above is attached to a flexographic printer by mounting brackets 70. The mounting brackets 70 hold the cleaning apparatus to the flexographic printer in such a way as to allow the cleaning head 60 to clean the anilox roller 30. The cleaning apparatus may be pivotally mounted 71 to the mounting brackets 70 such that the cleaning head 60 is pivoted into proximity with the anilox roller 30 during cleaning (see FIG. 8A) and pivoted away from the anilox roller 30 when not in use (see FIG. 8B).

The figures show specific embodiments of apparatuses according to the invention for use by the method. However, the illustrated apparatuses should not be seen as a complete presentation of conceivable embodiments. Thus, other apparatus designs and other apparatus parts, which are all covered by the method and the apparatuses according to the invention, may be deduced. Besides, the method according to the invention may be used for other types of cylinders than anilox cylinders; and rollers and cylinders in machines other than printing machines may be cleaned by means of the method according to the invention.

I claim:

1. A method of cleaning surfaces of an anilox roller comprising the steps of:
providing an anilox roller having surfaces to be cleaned of dried ink and other material residue;
providing a source of pressurized steam; and
directing a jet of said pressurized steam from said source onto said surfaces of said anilox roller, thereby removing said dried ink and other material residue from said surfaces of said anilox roller.

2. The method of claim 1, wherein said pressurized steam has a pressure of up to 1600 psi.

3. The method of claim 2, wherein said pressurized steam has a pressure of between 50 and 600 psi.

4. The method of claim 3, wherein said pressurized steam has a pressure of between 50 and 250 psi.

5. The method of claim 1, wherein said pressurized steam has a temperature of up to 350° F.

6. The method of claim 5, wherein said pressurized steam has a temperature of between 220 and 300° F.

7. The method of claim 6, wherein said pressurized steam has a temperature of between 220 and 260° F.

8. The method of claim 1, wherein said pressurized steam has a liquid water content of up to 10%.

9. The method of claim 1, including the further step of directing a stream liquid water onto said surfaces of said anilox roller after said step of directing a jet of said pressurized steam.

10. The method of claim 1, including the further step of providing a surfactant or degreasing compound on the surfaces of said anilox roller before said step of directing a jet of said pressurized steam.

11. The method of claim 1, comprising the further step of collecting the removed ink and other material residue from said roller via gravity-fed liquid collection, vacuum collection, or both.

12. The method of claim 11, wherein said removed ink and other material residue are collected from said roller via vacuum collection.

13. The method of claim 11, comprising the further step of transporting the collected ink and other material residue to a disposal system.

14. The method of claim 13, comprising the further step of disposing of said collected ink and other material residue.

15. An apparatus for cleaning dried ink and other material residue from surfaces of an anilox roller comprising:
a source of pressurized steam;
means for holding and rotating said anilox roller; and
means for directing at least one jet of said pressurized steam onto said surfaces of said anilox roller to remove said dried ink and other material residue.

16. The apparatus of claim 15, wherein said means for directing at least one jet of pressurized steam comprises at least one steam supply line and at least one steam jet nozzle.

17. The apparatus of claim 15, further including a means for directing at least one stream of liquid water onto said surfaces of said anilox roller to rinse away said dried ink and other material residue.

18. The apparatus of claim 17, wherein said means for directing at least one stream of liquid water includes a source of liquid water, a transport line, and a spray nozzle.

19. The apparatus of claim 15, further including a means for directing at least one stream of surfactant or degreasing compound onto the surfaces of said anilox roller.

20. The apparatus of claim 19, wherein said means for directing at least one stream of surfactant or degreasing compound includes a source thereof, a transport line, and an applicator nozzle.

21. The apparatus of claim 15, further comprising means for collecting said removed ink and other material residue from said anilox roller.

22. The apparatus of claim 21, wherein said means for collecting said removed ink and other material residue from said anilox roller comprises at least one of a vacuum collection system, a gravity-fed liquid collection system, or both in combination.

23. The apparatus of claim 22, wherein said means for collecting said removed ink and other material residue from said anilox roller comprises a vacuum collection system.

24. The apparatus of claim 23, wherein said vacuum collection system includes at least one vacuum port and at least one vacuum waste disposal line.

25. The apparatus of claim 22, wherein said means for collecting said removed ink and other material residue from said anilox roller comprises a gravity-fed liquid collection system.

26. The apparatus of claim 25, wherein said gravity-fed liquid collection system includes at least one liquid drip pan and at least one liquid waste drain line.

27. The apparatus of claim 23, wherein said means for directing at least one jet of high pressure steam onto the surface of said anilox roller and said vacuum collection system are combined into a single cleaning head.

28. The apparatus of claim 27, wherein said cleaning head is adapted to raster-scan the length of the anilox roller as it cleans the roller.

29. The apparatus of claim 28, further comprising a traction unit for raster scanning said cleaning head.

30. The apparatus of claim 27, wherein said cleaning head spans the entire length of the anilox roller.

31. The apparatus of claim 27, wherein said apparatus is a stand alone anilox roller cleaning unit.

32. The apparatus of claim 27, wherein said apparatus is adapted to be temporarily attached to a flexographic print machine for cleaning of the anilox roller thereof.

33. The apparatus of claim 27, wherein said apparatus is adapted to be permanently attached to a flexographic print machine for cleaning of the anilox roller thereof.

34. The apparatus of claim 33, wherein said apparatus is attached to said flexographic print machine using at least one mounting bracket.

35. The apparatus of claim 34, wherein said apparatus is pivotally attached to at least one mounting bracket such that the cleaning apparatus may be pivoted towards said anilox roller to clean it and pivoted away from said anilox roller when not in use.
